(19) United States
(12) Patent Application Publication
(10) Pub. No.: US 2022/0087414 A1
(43) Pub. Date: Mar. 24, 2022

(54) PROJECTION TABLE

(71) Applicant: IVIEW DISPLAYS (SHENZHEN) COMPANY LTD., Shenzhen (CN)

(72) Inventors: Yu Zhou, Shenzhen (CN); Mingnei Ding, Shenzhen (CN); Steve Yeung, Hong Kong (CN); Zhiqiang Gao, Hong Kong (CN)

(21) Appl. No.: 17/516,779

(22) Filed: Nov. 2, 2021

Related U.S. Application Data
(63) Continuation of application No. PCT/CN2021/079769, filed on Mar. 9, 2021.

(30) Foreign Application Priority Data
Sep. 23, 2020 (CN) 202022112297.4

(51) Int. Cl. A47B 37/02; A47B 13/16; G03B 21/54; G03B 21/28; G03B 21/14

(52) U.S. Cl. CPC A47B 37/02; A47B 13/16; A47B 2200/008; G03B 21/28; G03B 21/145; G03B 21/54

(57) ABSTRACT

The present disclosure provides a projection table. The projection table includes: a table body, including a table plate and defining a receiving space under the table plate; a support and adjustment device, disposed in the receiving space, and configured to support a projector and adjust a position of the projector in the receiving space in at least one direction of a top-and-bottom direction, a back-and-forth direction, and a left-and-right direction; a first mirror, disposed in the receiving space, and configured to receive a light ray emitted from the projector and reflect the light ray; and a second mirror, disposed in the receiving space, and configured to receive the light ray reflected from the first mirror and reflect the light ray out of the receiving space.

### CROSS-REFERENCE TO RELATED APPLICATIONS

This application is a continuation-application of International (PCT) Patent Application No. PCT/CN2021/079769, filed on Mar. 9, 2021, which claims priority to Chinese Patent Application No. 202022112297.4, filed with the National Intellectual Property Administration of China on Sep. 23, 2020, and entitled “PROJECTION TABLE”, the entire contents of which are incorporated herein by reference.

### TECHNICAL FIELD

The present disclosure relates to the technical field of digital projection and display, and in particular, relates to a projection table.

### BACKGROUND

As the demands on projection devices in various fields increase, office projectors are being highly demanded in the office field. Various office projectors with high-performance such as high-resolution, high-color, high-luminance and the like are being developed, such that the projectors are well promoted in the office field.

However, conventional office projectors are mostly desk-mounted or ceiling-mounted. The desk-mounted projector needs to be manually operated each time during use. These operations include placing the projectors, inserting and connecting cables, adjusting a projection region, receiving the projector and the like. As compared with the desk-mounted projector, the ceiling-mounted projector has merits as follows: during ceiling-mounting, the cables are property inserted and connected, the projector is placed well, and the projection region is also adjusted; and in subsequent use, the above operations are not needed. However, the ceiling-mounted projector also has some defects as compared with the desk-mounted projector. For example, a bracket for ceiling-mounting is needed, and the bracket needs to be adaptive to the projector, which is generally not universal. Where the projection region, the projection angle, and the projection size need to be adjusted, the operator needs to climb to adjust the bracket of the ceiling-mounted projector. As a result, not only the bracket needs to be equipped with an adjustment function, but also the operation is not convenient and time-consuming and laboring. Where the bracket is not equipped with the adjustment function, the ceiling-mounted projector fails to accommodate the above adjustment needs.

Accordingly, the conventional desk-mounted projector and ceiling-mounted projector both have some deficiencies.

### SUMMARY

An embodiment of the present disclosure provides a projection table. The projection table includes: a table body, including a table plate and defining a receiving space under the table plate; a support and adjustment device, disposed in the receiving space, and configured to support a projector and adjust a position of the projector in the receiving space in at least one direction of a top-and-bottom direction, a back-and-forth direction, and a left-and-right direction; a first mirror, disposed in the receiving space, and configured to receive a light ray emitted from the projector and reflect the light ray; and a second mirror, disposed in the receiving space, and configured to receive the light ray reflected from the first mirror and reflect the light ray out of the receiving space.

Another embodiment of the present disclosure provides a projection table. The projection table includes: a table body, including a table plate and defining a receiving space under the table plate; a support and adjustment device, disposed in the receiving space, and configured to support a projector and adjust a position of the projector in the receiving space; a first mirror, disposed in the receiving space, and configured to receive a light ray emitted from the projector and reflect the light ray; and a second mirror, disposed in the receiving space, and configured to receive the light ray reflected from the first mirror and reflect the light ray out of the receiving space.

### BRIEF DESCRIPTION OF THE DRAWINGS

One or more embodiments are illustrated by way of example, and not by limitation, in the figures of the accompanying drawings, wherein components having the same reference numeral designations represent like components throughout. The drawings are not to scale, unless otherwise disclosed.

FIG. 1 is a schematic perspective view of a projection table according to an embodiment of the present disclosure.

FIG. 2 is a sectional view of the projection table in FIG. 1, wherein an optical path of a projector mounted inside the projection table is illustrated.

FIG. 3 is a schematic perspective view of a support and adjustment device and a mirror of the projection table in FIG. 2.

FIG. 4 is a schematic plan view of a clamping mechanism of the projection table in FIG. 2, wherein a non-clamping state of the clamping mechanism is illustrated.

FIG. 5 is another schematic plan view of the clamping mechanism in FIG. 4, wherein a clamping state of the clamping mechanism for the projector is illustrated.

### DETAILED DESCRIPTION

For better understanding of the present disclosure, the present disclosure is described in detail with reference to attached drawings and specific embodiments. It should be noted that, when an element is defined as “being secured or fixed to/mounted to” another element, the element may be directly positioned on the element or one or more centered elements may be present therebetween. When an element is defined as “being connected or coupled to” another element, the element may be directly connected or coupled to the element or one or more centered elements may be present therebetween. In the description of the present disclosure, it should be understood that the terms “up”, “down”, “inner”, “outer”, “bottom”, “vertical”, “horizontal”, and the like indicate orientations and position relationships which are based on the illustrations in the accompanying drawings, and these terms are merely for ease and brevity of the description, instead of indicating or implying that the devices or elements shall have a particular orientation and shall be structured and operated based on the particular orientation. Accordingly, these terms shall not be construed as limiting the present disclosure. In addition, the terms “first”, “second”, and the like are merely for the illustration purpose, and shall not be construed as indicating or implying a relative importance.

Unless the context clearly requires otherwise, throughout the specification and the claims, technical and scientific terms used herein denote the meaning as commonly understood by a person skilled in the art. Additionally, the terms used in the specification of the present disclosure are merely for describing the objectives of the specific embodiments, and are not intended to limit the present disclosure. As used herein, the term “and/or” in reference to a list of one or more items covers all of the following interpretations of the term: any of the items in the list, all of the items in the list and any combination of the items in the list.

In addition, technical features involved in various embodiments of the present disclosure described hereinafter may be combined as long as these technical features are not in conflict.

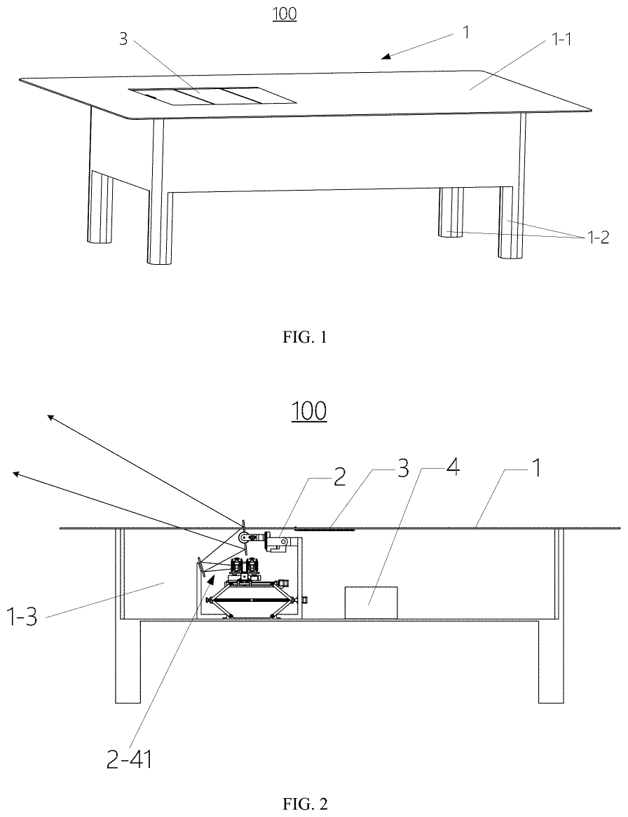

An embodiment of the present disclosure provides a projection table. As illustrated in FIG. 1 and FIG. 2, a projection table 100 mainly includes a table body 1, a projection device 2, a foldable panel 3, and a control unit 4.

The table body 1 in the projection table 100 may be a desk, a conference table, or the like. The table body may be designed to a customized dimension according to the actual needs, or may be made by changing a conventional desk satisfying the needs. The table body 1 may include a table plate 1-1 and a plurality of legs 1-2, and may define a receiving space 1-3 under the table plate 1-1. The receiving space 1-3 may be defined as a closed space at the bottom together with the plates around, to shield and protect, together with the foldable panel 3, the projection device 2 therein. In addition, the receiving space 1-3 may also be not a closed space, which, for example, may be defined by the bracket as long as the projection device 2 can be mounted.

The foldable panel 3 may be disposed on the table plate 1-1, and is provided with a fold state and an unfold state. In the fold state, the foldable panel 3 at least partially exposes a top opening of the receiving space 1-3, to prevent impacts onto an optical path of the light ray reflected from the mirror and operation of the mirror. In the unfold state, the foldable panel 3 may close the top opening of the receiving space 1-3. In the case that the projection device 2 is not used, the foldable panel 3 may be in the unfold state, to shield and protect the projection device, which also keeps the table clean and tidy.

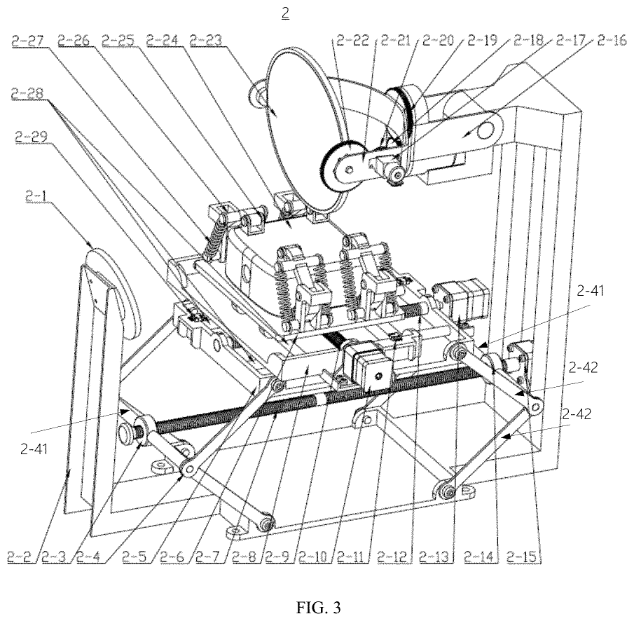

As illustrated in FIG. 2 and FIG. 3, the projection device may be disposed inside the table body 1. During use, the projection device 2 clamps the projector 2-24 thereon, reflects the projection picture of the projector 2-24 by the first mirror 2-1 and the second mirror 2-23 for two times, and adjust an angular position during the second reflection by using the motor where necessary, such that the projection picture is finally projected at a desired position. The first mirror 2-1 is disposed in the receiving space 1-3, and is configured to receive a light ray emitted from the projector 2-24 and reflect the light ray. The second mirror 2-23 is disposed in the receiving space 1-3, and is configured to receive the light ray reflected from the first mirror 2-1 and reflect the light ray out of the receiving space.

As illustrated in FIG. 3, the projection device 2 may include a support and adjustment device. The support and adjustment device is disposed in the receiving space 1-3, and is configured to support the projector 2-24 and adjust a position of the projector 2-24 in the receiving space 1-3 as desired. For example, the support and adjustment device may adjust the position of the projector 2-24 in at least one direction of a top-and-bottom direction, a back-and-forth direction, and a left-and-right direction. Further, the support and adjustment device may adjust the position of the projector 2-24 in the top-and-bottom direction, the back-and-forth direction, and the left-and-right direction.

In some embodiments, the support and adjustment device includes an elevation displacement adjustment mechanism. The elevation displacement adjustment mechanism includes: a base 2-2, disposed in the receiving space 1-3; a first lead screw assembly, driven by a first motor 2-15 disposed on the base 2-2; a first chassis 2-5; and a linkage assembly 2-4, connected between the first chassis 2-5 and the base 2-2, and connected to the first lead screw assembly and configured to change a height of the linkage assembly 2-4 to adjust a position of the first chassis 2-5 in a top-bottom direction in response to the first lead screw assembly being driven. Further, the base 2-2 may be further provided with two vertically arranged support arms, such that the first mirror 2-1 may be mounted on one of the support arms of the base 2-2 and the second mirror 2-23 may be mounted on the other support arm of the base 2-2.

Further, the first lead screw assembly includes a first lead screw 2-7, a first lead screw nut 2-3, and a second lead screw nut 2-14. The first lead screw 2-7 is driven to rotate by the first motor 2-15, and is meshed with first lead screw nut 2-3 and the second lead screw nut 2-14. The linkage assembly 2-4 may include two horizontal rods 2-41 and four groups of linkage mechanisms. Each group of the linkage mechanisms is provided with two linkages 2-42 pivotally connected. Two ends of each group of the linkage mechanisms are respectively pivotally connected to the first chassis 2-5 and the base 2-2. Each of the horizontal rods 2-41 is connected between corresponding two groups of the linkage mechanisms and is arranged about a pivot center of the two groups of linkage mechanisms. The first lead screw nut 2-3 and the second lead screw nut 2-14 are respectively connected to the two horizontal rods 2-41. The first motor 2-15 may be an elevation displacement step motor. The first lead screw 2-7 may be provided with two sections of threads in different spiral directions such that the first lead screw 2-7 drives the first lead screw nut 2-3 and the second lead screw nut 2-14 towards two divergent directions or drives the first lead screw nut 2-3 and the second lead screw nut 2-14 towards two convergent directions in the case that the first motor 2-15 is meshed with the first lead screw nut 2-3 the second lead screw nut 2-14 and rotates.

In some embodiments, the support and adjustment device further includes a back-and-forth displacement adjustment mechanism. The back-and-forth displacement adjustment mechanism includes: the first chassis 2-5, mounted with a first slide rail 2-28, a back-and-forth displacement lead screw 2-12, and a second motor 2-13, wherein the back-and-forth displacement lead screw 2-12 is driven to rotate by the second motor 2-13; and a third chassis 2-8, wherein a bottom of the third chassis 2-8 is mounted with a lead screw nut mating with the back-and-forth displacement lead screw 2-12 and a slide ring mating with the first slide rail 2-28. Further, the first chassis is further provided with a back-and-forth displacement limiter 2-29. The second motor 2-13 may be a back-and-forth displacement step motor. The displacement limiter herein may be a position switch or a limit switch, which turns on or turns off a control circuit by causing a contact of a motion element to effect by virtue of collision of the motion element, and thereby achieves the control objective. Generally, such displacement limiters are employed to limit a position or stroke of a mechanical motion, such that the mechanical motion is stopped, reversed, accelerated or deaccelerated or automatically reciprocated in accordance with a specific position or stroke.

In some embodiments, the support and adjustment device further includes a left-and-right displacement adjustment mechanism. The left-and-right displacement adjustment mechanism includes: the third chassis 2-8, mounted with a second slide rail 2-28, a left-and-right displacement lead screw 2-9, and a third motor 2-10, wherein the left-and-right displacement lead screw 2-9 is driven to rotate by the third motor 2-10; and a second chassis 2-6, wherein a bottom of the second chassis 2-6 is mounted with a lead screw nut mating with the left-and-right displacement lead screw 2-9 and a slide ring mating with the second slide rail 2-28, and the second chassis 2-6 is configured to support the projector 2-24. Further, the third chassis 2-8 is further provided with a left-and-right displacement limiter 2-11. The third motor 2-10 may be a left-and-right displacement step motor.

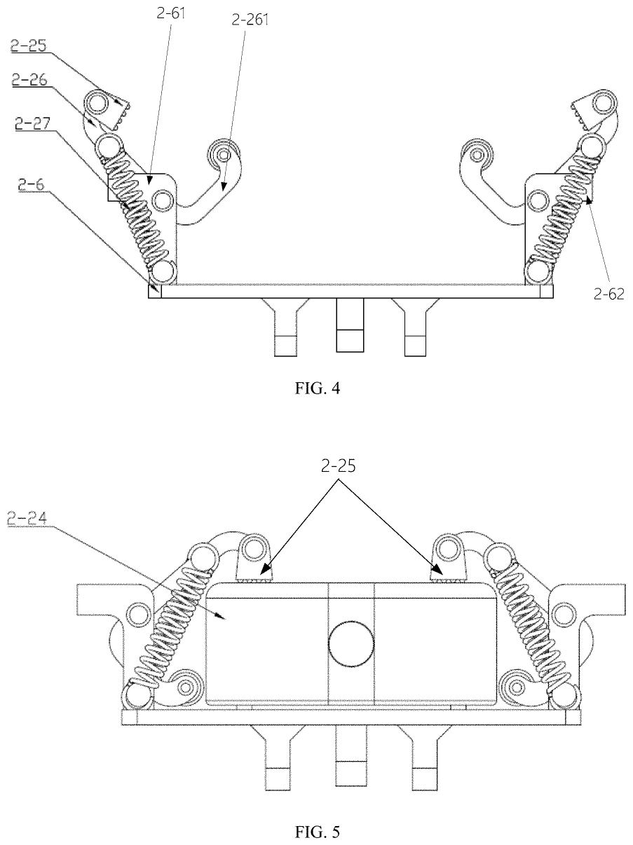

In some embodiments, as illustrated in FIG. 3, FIG. 4, and FIG. 5, the second chassis 2-6 may be provided with a clamping mechanism. The clamping mechanism is configured to clamp the projector 2-24 and includes: a bracket 2-61, disposed on the second chassis 2-6; a movable rod 2-26, pivotally disposed on the bracket, and provided with a pivotally connected pressing claw 2-25 at one end thereof; and a movable rod spring 2-27, wherein two ends of the movable rod spring are respectively connected to the movable rod 2-26 and the bracket 2-61. The movable rod 2-26 is provided with a first position and a second position under a tension of the movable rod spring 2-27. The movable rod 2-26, in response to being at the first position, drives the pressing claw 2-25 to rotate towards the outside of the second chassis 2-6 to define a space for receiving the projector 2-24; and the movable rod 2-26, in response to being at the second position, drives the pressing claw 2-25 to rotate towards the inside of the second chassis 2-6, such that the pressing claw 2-25 tightly presses the projector 2-24 against the second chassis 2-6. As illustrated in the drawings, the number of brackets 2-61, the number of pressing claws 2-25, the number of movable rods 2-26, the number of movable rod springs 2-27 are all two, such that two sets of movable mechanisms for simultaneously clamping on two sides of the projector 2-24. In addition, the pivotal configuration herein refers to that two elements are connected to each other and pivotable with respect to each other. For example, the two elements may be assembled and fixed by a pin shaft, and one of the elements is capable of rotating with respect to the other element about the pin shaft.

Further, with respect to the end provided with the pressing claw 2-25, the other end of the movable rod 2-26 may be a pressing rod 2-261 defining a specific angle with a main part of the movable rod 2-26. As such, in the case that the projector 2-24 is disposed on the second chassis 2-6, the pressing rod 2-261 is pressed down by the projector 2-24, the pressing rod 2-261 is capable of driving the movable rod 2-26 to rotate entirely towards the projector 2-24, such that the movable rod 2-26 is pulled, under contraction of the movable rod spring 2-27, to move towards a tension direction of the movable rod spring 2-27 about a rotation shaft in cooperation with the bracket 2-61 of the second base 2-6, and meanwhile the pressing claw 2-25 is capable of rotating about the rotation shaft in cooperation with the movable rod 2-26. Finally, the projection 2-24 is tightly pressed by the pressing claw 2-25.

In some other embodiments, a surface of the pressing claw 2-25 is provided with rubber teeth configured to prevent a skid in a contact area between the surface of the pressing claw 2-25 and an upper surface of the projector 2-24. The bracket 2-61 is provided with a limiting portion 2-62, wherein the limiting portion 2-62 is abutted against the movable rod 2-26 to retain the movable rod 2-26 at the second position in response to the movable rod 2-26 rotating to the outside of the second chassis 2-6.

As illustrated in FIG. 4, in the case that the projector 2-24 is not clamped, under the action of the movable rod spring 2-27, the movable rod 2-26 moves towards the tension direction of the movable rod spring 2-27 about the rotation shaft in cooperation with the bracket 2-61 of the second base 2-6, and is stopped by the limiting portion 2-62, such that an open state is maintained. The clamping mechanism may top-and-bottom clamp or left-and-right clamp the projector 2-24, and thus is applicable to rapid clamping or declamping of most of the projectors in the market.

Still as illustrated FIG. 3, in some embodiments, the projection device 2 may further include a transverse rolling mechanism configured to drive the second mirror 2-23 to transversely roll. The transverse rolling mechanism is disposed in the receiving space and includes: the base 2-2; a first structure support 2-16, pivotally connected to the base 2-2; a first gear 2-18, mounted on the first structure support 2-16; a fourth motor (not illustrated in the drawings, and similar to the fifth motor 2-17 hereinafter), mounted on the first structure support 2-16, and configured to drive the first gear 2-18; a second gear 2-19, connected to a second structure support 2-21 mounted with the second mirror 2-23, and pivotally mounted on the first structure support 2-16, such that the first gear 2-18 is meshed with the second gear 2-19.

The first structure support 2-16 may be assembled and fixed to the pin shaft of the base 2-2, and may rotate within a range of 0 to 90 degrees about the pin shaft, which may be manually rotated. In addition, the fourth motor is a small-size step motor.

In some embodiments, the second structure support 2-21 is provided with a pitching mechanism. The pitching mechanism may include: a third gear 2-20, mounted on the second structure support 2-21; a fifth motor 2-17, mounted on the second structure support 2-21, and configured to drive the third gear 2-20; and a fourth gear 2-22, mounted on the second structure support 2-21, and meshed with the third gear 2-20. The second mirror 2-23 is fixedly assembled with the fourth gear 2-23, such that the fourth gear 2-22, in response to being driven to rotate, drives the second mirror 2-23 to pitch.

Further, as illustrated in FIG. 2, the control unit 4 of the projection table 100 may be mounted on the table body 1, and configured to control motion of the projector 2-24. For example, the control unit 4 may be integrated with functions including motion control and interactions with external data (a remote control, a personal computer, and the like), a power source, and the like.

Assembling and adjustment of the projector 2-24 are described briefly hereinafter.

First, where the projector 2-24 needs to be mounted, the first structure support 2-16 is rotated upward by 90 degrees about the pin shaft assembled with the base 2-2, such that the transverse rolling and pitching structure of the second mirror 2-23 avoid a mounting operation space of the projector 2-24. Second, the projector 2-24 is clamped to the second chassis 2-6 by the clamping mechanism, and the first structure support 2-16 is rotated downward by 90 degrees to a structure mechanical stop position about the pin shaft assembled with the base 2-2.

Then, by using the control unit 4, the remote control or the personal computer may control the motor 2-10 of the left-and-right displacement step motor to drive the left-and-right displacement lead screw 2-9 to rotate, such that the second chassis 2-6 moves left and right; control the motor 2-13 of the back-and-forth displacement step motor to drive the back-and-forth displacement lead screw 2-12 to rotate, such that the third chassis 2-8 moves left and right; and control the elevation displacement step motor 2-15 to drive the elevation displacement lead screw 2-7 to rotate, such that the first chassis 2-5 is elevated. As such, a projection picture of the projector 2-24 is at the center of the first mirror 2-1 and the second mirror 2-23. Finally, the remote control or the personal computer may control the second mirror 2-23 to transversely roll or pitch, such that the projection picture is projected onto a desired region.

In summary, the projection table according to the embodiments of the present disclosure may be practiced as a semiautomatic projection conference table device for office use.

As compared with the related art, the present disclosure achieves the following beneficial effects. Different from the related art, the projection table according to the embodiments of the present disclosure defines a receiving space under the table plate, and a support and adjustment device is disposed in the receiving space. The support and adjustment device is configured to support a projector and is capable of adjusting a position of the projector in a top-and-bottom direction, a back-and-forth direction, and a left-and-right direction. Further, by cooperation between a first mirror and a second mirror, light rays emitted from the projector are reflected out of the receiving space. With the above configuration, in the projection table according to the present disclosure, the projector may be disposed in a concealed fashion, occupying no space of the surface of the table and requiring no receive operations. In addition, the position of the projector may be conveniently adjusted, such that the projection region of the projector is adjusted. In addition, the projection table according to the embodiments of the present disclosure also implements quick mounting and clamping of the projector, and is thus applicable to multiple types of projectors for office use. Further, the projection table is capable of adjusting the projection region to a great extent based on a user instruction issued by the remote control, for example. Further, with the projection table, dynamic projection may also be implemented by using internal programming, for example, dynamic projection for atmosphere creation and rendering for entertainment and office use.

Described above are exemplary embodiments of the present disclosure, but are not intended to limit the scope of the present disclosure. Any equivalent structure or equivalent process variation made based on the specification and drawings of the present disclosure, which is directly or indirectly applied in other related technical fields, fall within the scope of the present disclosure.

1. A projection table, comprising:
a table body, comprising a table plate and defining a receiving space under the table plate;
a support and adjustment device, disposed in the receiving space, and configured to support a projector and adjust a position of the projector in the receiving space in at least one direction of a top-and-bottom direction, a back-and-forth direction, and a left-and-right direction;
a first mirror, disposed in the receiving space, and configured to receive a light ray emitted from the projector and reflect the light ray; and
a second mirror, disposed in the receiving space, and configured to receive the light ray reflected from the first mirror and reflect the light ray out of the receiving space.

2. The projection table according to claim 1, wherein
the support and adjustment device comprises an elevation displacement adjustment mechanism, wherein the elevation displacement adjustment mechanism comprises:
a base, disposed in the receiving space;
a first lead screw assembly, driven by a first motor disposed on the base;
a first chassis; and
a linkage assembly, connected between the first chassis and the base, and connected to the first lead screw assembly and configured to change a height of the linkage assembly to adjust a position of the first chassis in a top-bottom direction in response to the first lead screw assembly being driven.

3. The projection table according to claim 2, wherein
the first mirror is mounted on the base; and/or
the second mirror is mounted on the base.

4. The projection table according to claim 2, wherein
the first lead screw assembly comprises a first lead screw, a first lead screw nut, and a second lead screw nut, wherein the first lead screw is driven to rotate by the first motor, and is meshed with first lead screw nut and the second lead screw nut; and
the linkage assembly comprises two horizontal rods and four groups of linkage mechanisms, wherein each group of the linkage mechanisms is provided with two linkages pivotally connected, two ends of each group of the linkage mechanisms are respectively pivotally connected to the first chassis and the base, each of the horizontal rods is connected between corresponding two groups of the linkage mechanisms and is arranged about a pivot center of the two groups of linkage mechanisms, and the first lead screw nut and the second lead screw nut are respectively connected to the two horizontal rods.

5. The projection table according to claim 2, wherein
the support and adjustment device further comprises a back-and-forth displacement adjustment mechanism, wherein the back-and-forth displacement adjustment mechanism comprises:
the first chassis, mounted with a first slide rail, a back-and-forth displacement lead screw, and a second motor, wherein the back-and-forth displacement lead screw is driven to rotate by the second motor; and
a third chassis, wherein a bottom of the third chassis is mounted with a lead screw nut mating with the back-and-forth displacement lead screw and a slide ring mating with the first slide rail.

6. The projection table according to claim 5, wherein the first chassis is further provided with a back-and-forth displacement limiter.

7. The projection table according to claim 5, wherein
the support and adjustment device further comprises a left-and-right displacement adjustment mechanism, wherein the left-and-right displacement adjustment mechanism comprises:
the third chassis, mounted with a second slide rail, a left-and-right displacement lead screw, and a third motor, wherein the left-and-right displacement lead screw is driven to rotate by the third motor; and
a second chassis, wherein a bottom of the second chassis is mounted with a lead screw nut mating with the left-and-right displacement lead screw and a slide ring mating with the second slide rail, and the second chassis is configured to support the projector.

8. The projection table according to claim 7, wherein the third chassis is further provided with a left-and-right displacement limiter.

9. The projection table according to claim 1, wherein the support and adjustment device comprises a second chassis, wherein the second chassis is configured to support the projector.

10. The projection table according to claim 9, wherein
the second chassis is provided with a clamping mechanism, wherein the clamping mechanism is configured to clamp the projector and comprises:
a bracket, disposed on the second chassis;
a movable rod, pivotally disposed on the bracket, and provided with a pivotally connected pressing claw at one end thereof;
a movable rod spring, wherein two ends of the movable rod spring are respectively connected to the movable rod and the bracket;
wherein the movable rod is provided with a first position and a second position under a tension of the movable rod spring; the movable rod, in response to being at the first position, drives the pressing claw to rotate towards the outside of the second chassis; and the movable rod, in response to being at the second position, drives the pressing claw to rotate towards the inside of the second chassis, such that the pressing claw tightly presses the projector against the second chassis.

11. The projection table according to claim 10, wherein
a surface of the pressing claw is provided with rubber teeth configured to prevent a skid in a contact area between the surface of the pressing claw and an upper surface of the projector; and/or
the bracket is provided with a limiting portion, wherein the limiting portion is abutted against the movable rod to retain the movable rod at the second position in response to the movable rod rotating to the outside of the second chassis.

12. The projection table according to claim 1, further comprising a transverse rolling mechanism, configured to drive the second mirror to transversely roll, wherein the transverse rolling mechanism is disposed in the receiving space and comprises:
a base, disposed in the receiving space;
a first structure support, pivotally connected to the base;
a first gear, mounted on the first structure support;
a fourth motor, mounted on the first structure support, and configured to drive the first gear;
a second gear, connected to a second structure support mounted with the second mirror, and pivotally mounted on the first structure support, such that the first gear is meshed with the second gear.

13. The projection table according to claim 12, wherein
the second structure support is provided with a pitching mechanism, wherein the pitching mechanism comprises:
a third gear, mounted on the second structure support;
a fifth motor, mounted on the second structure support, and configured to drive the third gear; and
a fourth gear, mounted on the second structure support, and meshed with the third gear, wherein the second mirror is fixedly assembled with the fourth gear.

14. The projection table according to claim 1, further comprising a foldable panel, wherein the foldable panel is disposed on the table plate, and is provided with a fold state and an unfold state; wherein in the fold state, the foldable panel at least partially exposes a top opening of the receiving space, and in the unfold state, the foldable panel closes the top opening of the receiving space.

15. The projection table according to claim 1, further comprising:
the projector, disposed on the support and adjustment device; and/or
a control unit, mounted on the table body, and configured to control motion of the projector.

16. A projection table, comprising:
a table body, comprising a table plate and defining a receiving space under the table plate;
a support and adjustment device, disposed in the receiving space, and configured to support a projector and adjust a position of the projector in the receiving space;
a first mirror, disposed in the receiving space, and configured to receive a light ray emitted from the projector and reflect the light ray; and
a second mirror, disposed in the receiving space, and configured to receive the light ray reflected from the first mirror and reflect the light ray out of the receiving space.

17. The projection table according to claim 16, wherein
the support and adjustment device comprises an elevation displacement adjustment mechanism, wherein the elevation displacement adjustment mechanism comprises:
a base, disposed in the receiving space;
a first lead screw assembly, driven by a first motor disposed on the base;
a first chassis; and
a linkage assembly, connected between the first chassis and the base, and connected to the first lead screw assembly and configured to change a height of the linkage assembly to adjust a position of the first chassis in a top-bottom direction in response to the first lead screw assembly being driven.

18. The projection table according to claim 16, wherein the support and adjustment device comprises a second chassis, wherein the second chassis is configured to support the projector.

19. The projection table according to claim 16, further comprising a transverse rolling mechanism, configured to drive the second mirror to transversely roll, wherein the transverse rolling mechanism is disposed in the receiving space and comprises:
a base, disposed in the receiving space;
a first structure support, pivotally connected to the base;
a first gear, mounted on the first structure support;
a fourth motor, mounted on the first structure support, and configured to drive the first gear;
a second gear, connected to a second structure support mounted with the second mirror, and pivotally mounted on the first structure support, such that the first gear is meshed with the second gear.

20. The projection table according to claim 16, further comprising:
the projector, disposed on the support and adjustment device; and
a control unit, mounted on the table body, and configured to control motion of the projector.
